(19) United States
(12) Patent Application Publication
(10) Pub. No.: US 2012/0281236 A1
(43) Pub. Date: Nov. 8, 2012

(54) FOUR-DIMENSIONAL OPTICAL COHERENCE TOMOGRAPHY IMAGING AND GUIDANCE SYSTEM

(75) Inventors: Jin U. Kang, Ellicott City, MD (US); Kang Zhang, Baltimore, MD (US)

(73) Assignee: The Johns Hopkins University, Baltimore, MD (US)

(21) Appl. No.: 13/464,758

(22) Filed: May 4, 2012

Related U.S. Application Data
(60) Provisional application No. 61/482,294, filed on May 4, 2011.

(51) Int. Cl. G01B 9/02

(52) U.S. Cl. 356/479

(57) ABSTRACT

A four-dimensional optical coherence tomography imagining and guidance system includes an optical coherence tomography system, a data processing system adapted to communicate with the optical coherence tomography system, and a display system adapted to communicate with the data processing system. The optical coherence tomography system is configured to provide data corresponding to a plurality of volume frames per second. The data processing system is configured to receive and process the data and provide three-dimensional image data to the display system such that the display system displays a rendered real-time three-dimensional image.

### CROSS-REFERENCE OF RELATED APPLICATION

This application claims priority to U.S. Provisional Application No. 61/482,294 filed May 4, 2011, the entire content of which is hereby incorporated by reference.

This invention was made with Government support of Grant No. R21 1R21NS063131-01A1, awarded by the Department of Health and Human Services, The National Institutes of Health (NIH). The U.S. Government has certain rights in this invention.

### BACKGROUND

1. Field of Invention

The field of the currently claimed embodiments of this invention relates to optical coherence tomography imaging and guidance systems.

2. Discussion of Related Art

Microsurgery requires both physical and optical access to limited space in order to perform tasks on delicate tissue. The ability to view critical parts of the surgical region and work within micron proximity to the fragile tissue surface requires excellent visibility and precise instrument manipulation. The surgeon needs to function within the limits of human sensory and motion capability to visualize targets, steadily guide microsurgical tools and execute all surgical targets. These directed surgical maneuvers must occur intraoperatively with minimization of surgical risk and expeditious resolution of complications. Conventionally, visualization during the operation is realized by surgical microscopes, which limits the surgeon's field of view (FOV) to the en face scope [1], with limited depth perception of micro-structures and tissue planes.

As a noninvasive imaging modality, optical coherence tomography (OCT) is capable of cross-sectional micrometer-resolution images and a complete 3D data set could be obtained by 2D scanning of the targeted region. Compared to other modalities used in image-guided surgical intervention such as MRI, CT, and ultrasound, OCT is highly suitable for applications in microsurgical guidance [1-3]. For clinical intraoperative purposes, a FD-OCT system should be capable of ultrahigh speed raw data acquisition as well as matching-speed data processing and visualization. In recent years, the A-scan acquisition rate of FD-OCT systems has generally reached multi-hundred-of-thousand line/second level [4,5] and approaches multi-million line/second level [6,7]. The recent developments of graphics processing unit (GPU) accelerated FD-OCT processing and visualization have enabled real-time 4D (3D+time) imaging at the speed up to 10 volume/second [8-10]. However, these systems all work in the standard mode, and therefore suffer from spatially reversed complex-conjugate ghost images. During intraoperative imaging, for example, when long-shaft surgical tools are used, such ghost images could severely misguide the surgeons. As a solution, GPU-accelerated full-range FD-OCT has been utilized and real-time B-scan images was demonstrated with effective complex-conjugate suppression and doubled imaging range [11,12]. Therefore, there remains a need for improved optical coherence tomography imaging and guidance systems.

### SUMMARY

A four-dimensional optical coherence tomography imagining and guidance system according to an embodiment of the current invention includes an optical coherence tomography system, a data processing system adapted to communicate with the optical coherence tomography system, and a display system adapted to communicate with the data processing system. The optical coherence tomography system is configured to provide data corresponding to a plurality of volume frames per second. The data processing system is configured to receive and process the data and provide three-dimensional image data to the display system such that the display system displays a rendered real-time three-dimensional image.

### BRIEF DESCRIPTION OF THE DRAWINGS

Further objectives and advantages will become apparent from a consideration of the description, drawings, and examples.

FIG. 1 is a schematic illustration of a four-dimensional optical coherence tomography imagining and guidance system according to an embodiment of the current invention. In this example, the system configuration is as follows: CMOS, CMOS line scan camera; G, grating; L1, L2, L3, L4 achromatic collimators; C, 50:50 broadband fiber coupler; CL, camera link cable; CTRL, galvanometer control signal; GVS, galvanometer pairs (only the first galvanometer is illustrated for simplicity); SL, scanning lens; DCL, dispersion compensation lens; M, reference mirror; PC, polarization controller.

FIG. 2 provides a signal processing flow chart of the dual-GPUs architecture according to an embodiment of the current invention. Dashed arrows, thread triggering; Solid arrows, main data stream; Hollow arrows, internal data flow of the GPU. Here the graphics memory refers to global memory.

FIGS. 3A-3C show optical performance of a system according to an embodiment of the current invention, in which: (a) PSFs processed by linear interpolation with FFT. (b) PSFs processed by NUFFT. (c) PSF comparison near the edge.

FIGS. 4A-4D show four-dimensional optical coherence tomography imagining and guidance system according to an embodiment of the current invention. Here (Media 1) In vivo human finger nail fold imaging: (a)-(d) are rendered from the same 3D data set with different view angles. The arrows/dots on each 2D frame correspond to the same edges/vertexes of the rendering volume frame. Volume size: 256(Y)×100(X)×1024(Z) voxels/3.5 mm (Y)×3.5 mm (X)×3 mm (Z).

FIGS. 5A-5D show four-dimensional optical coherence tomography imagining and guidance system according to an embodiment of the current invention. Here (Media 2) Real-time 4D full-range FD-OCT guided micro-manipulation using a phantom model and a vitreoretinal surgical forceps. The arrows/dots on each 2D frame correspond to the same edges/vertexes of the rendering volume frame. Volume size: 256(Y)×100(X)×1024(Z) voxels/3.5 mm (Y)×3.5 mm (X)×3 mm (Z).

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

The term “light” as used herein is intended to have a broad meaning that can include both visible and non-visible regions of the electromagnetic spectrum. For example, visible, near infrared, infrared and ultraviolet light are all considered as being within the broad definition of the term “light.” The term “real-time” is intended to mean that the OCT images can be provided to the user during use of the OCT system. In other words, any noticeable time delay between detection and image displaying to a user is sufficiently short for the particular application at hand. In some cases, the time delay can be so short as to be unnoticeable by a user.

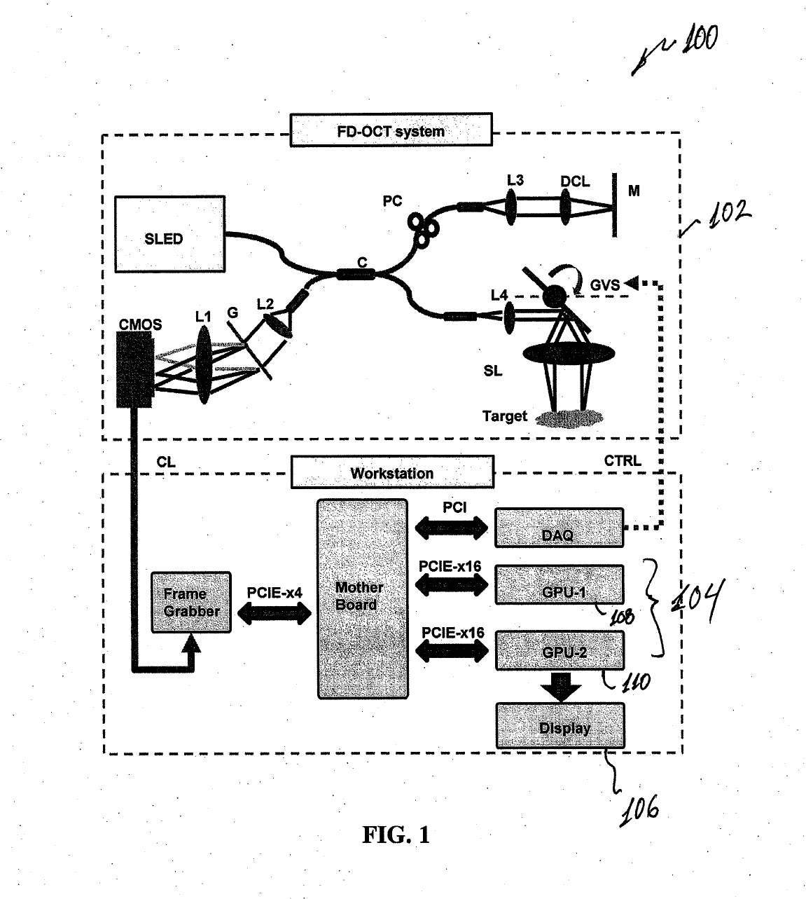

FIG. 1 is a schematic illustration of a four-dimensional optical coherence tomography imagining and guidance system 100 according to an embodiment of the current invention. The four-dimensional optical coherence tomography imagining and guidance system 100 includes an optical coherence tomography system 102, a data processing system 104 adapted to communicate with the optical coherence tomography system 102, and a display system 106 adapted to communicate with the data processing system 104. The optical coherence tomography system 102 is configured to provide data corresponding to a plurality of volume frames per second. The data processing system 104 is configured to receive and process the data and provide three-dimensional image data to the display system 106 such that the display system displays a rendered real-time three-dimensional image.

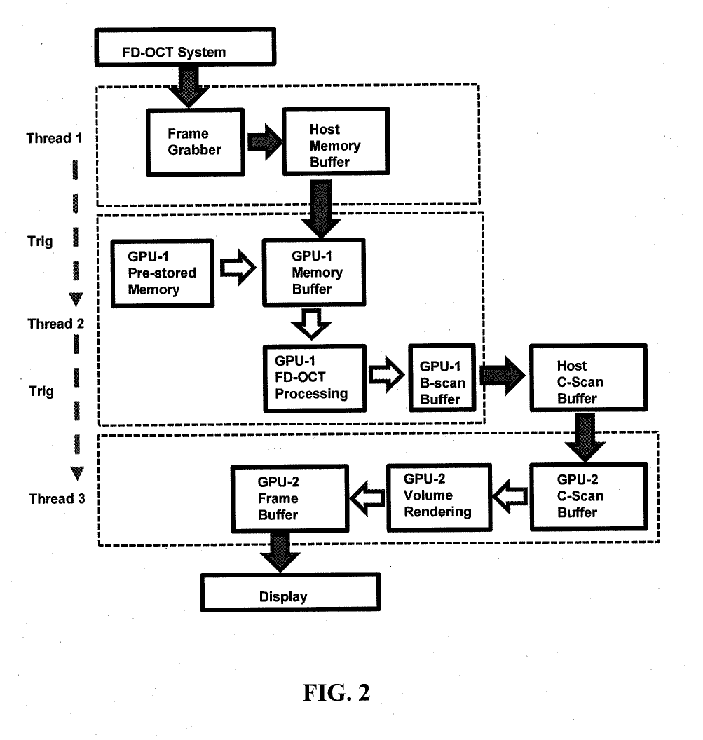

In some embodiments, the data processing system 104 can include at least one parallel processing unit. In an embodiment of the current invention, the data processing system 104 includes a first parallel processing unit 108 configured to receive and process the data from the optical coherence tomography system 102 to provide pre-processed data, and the data processing system 102 further includes a second parallel processing unit 110 configured to receive and process the pre-processed data to provide the three-dimensional image data to the display system 106. In some embodiments, the first parallel processing unit 108 can be a first graphics processing unit (GPU-1) and the second parallel processing unit 110 can be a second graphics processing unit (GPU-2). (See, also FIG. 2.)

In some embodiments, the optical coherence tomography system 102 can be a Fourier domain optical coherence tomography system. The optical coherence tomography system 102 can be a fiber-optic optical coherence tomography system, for example. In some embodiments, the optical coherence tomography system can include an optical fiber probe for microsurgery.

In some embodiments, the display system can be at least one of a monitor, a head-mounted display or a viewing port. In some embodiments, the monitor, head-mounted display or viewing port can provide real time microsurgical guidance, for example.

In some embodiments, the second graphics processing unit can be further configured to perform at least one of segmentation, information overlay, or image overlay of the rendered real-time three-dimensional image.

In further embodiments, the optical coherence tomography system can be a functional optical coherence tomography system to perform at least one of spectroscopic, speckle, Doppler or optical coherence tomography, or any combination thereof.

Further additional concepts and embodiments of the current invention will be described by way of the following examples. However, the broad concepts of the current invention are not limited to these particular examples.

### EXAMPLES

In this example, we implemented the real-time 4D full-range complex-conjugate-free FD-OCT based on the dual-GPUs architecture, where one GPU is dedicated to the FD-OCT data processing while the second one is used for the volume rendering and display. GPU based non-uniform fast Fourier transform (NUFFT) [12] is also implemented to suppress the side lobes of the point spread function and to improve the image quality. (See also, International Application No. PCT/US2011/066603, filed Dec. 21, 2011, assigned to the same assignee as the current application, the entire content of which is incorporated herein by reference for all purposes.) With a 128,000 A-scan/second OCT engine, we obtained 5 volumes/second 3D imaging and display. We have demonstrated the real-time visualization capability of the system by performing a micro-manipulation process using a vitro-retinal surgical tool and a phantom model. Multiple volume renderings of the same 3D data set were performed and displayed with different view angles. This embodiment of the current invention can provide the surgeon with comprehensive intraoperative imaging of the microsurgical region which could improve accuracy and safety of microsurgical procedures.

### System Configuration and Data Processing

The system configuration for the following examples is shown in FIG. 1. In the FD-OCT system section, a 12-bit dual-line CMOS line-scan camera (Sprint spL2048-140k, Basler AG, Germany) is used as the detector of the OCT spectrometer. A superluminescence diode (SLED) (λ0=825 nm, Δλ=70 nm, Superlum, Ireland) is used as the light source, giving a theoretical axial resolution of 5.5 μm in air. The transversal resolution was approximately 40 μm assuming a Gaussian beam profile. The CMOS camera is set to operate at the 1024-pixel mode by selecting the area-of-interest (AOI). The minimum line period is camera-limited to 7.8 μs, corresponding to a maximum line rate of 128 k A-scan/s, and the exposure time is 6.5 μs. The beam scanning was implemented by a pair of high speed galvanometer mirrors controlled by a function generator and a data acquisition (DAQ) card. The raw data acquisition is performed using a high speed frame grabber with camera link interface. To realize the full-range complex OCT mode, a phase modulation is applied to each B-scan's 2D interferogram frame by slightly displacing the probe beam off the first galvanometer's pivoting point (only the first galvanometer is illustrated in FIG. 1) [11-13].

A quad-core Dell T7500 workstation was used to host the frame grabber (PCIE-x4 interface), DAQ card (PCI interface), GPU-1 and GPU-2 (both PCIE-x16 interface), all on the same mother board. GPU-1 (NVIDIA GeForce GTX 580) with 512 stream processors, 1.59 GHz processor clock and 1.5 GBytes graphics memory is dedicated for raw data processing of B-scan frames. GPU-2 (NVIDIA GeForce GTS 450) with 192 stream processors, 1.76 GHz processor clock and 1.0 GBytes graphics memory is dedicated for the volume rendering and display of the complete C-scan data processed by GPU-1. The GPU is programmed through NVIDIA's Compute Unified Device Architecture (CUDA) technology [14]. The software is developed under the Microsoft Visual C++ environment with National Instrument's IMAQ Win32 APIs.

The signal processing flow chart of the dual-GPUs architecture according to this embodiment of the current invention is illustrated in FIG. 2, where three major threads are used for the FD-OCT system raw data acquisition (Thread 1), the GPU accelerated FD-OCT data processing (Thread 2), and the GPU based volume rendering (Thread 3). The three threads synchronize in the pipeline mode, where Thread 1 triggers Thread 2 for every B-scan and Thread 2 triggers Thread 3 for every complete C-scan, as indicated by the dashed arrows. The solid arrows describe the main data stream and the hollow arrows indicate the internal data flow of the GPU. Since the CUDA technology currently does not support direct data transfer between GPU memories, a C-Scan buffer is placed in the host memory for the data relay.

Compared to previously reported systems, this dual-GPU architecture separates the computing task of the signal processing and the visualization into different GPUs, which can provide the following advantages:
(1) Assigning different computing tasks to different GPUs makes the entire system more stable and consistent. For the real-time 4D imaging mode, the volume rendering is only conducted when a complete C-scan is ready, while B-scan frame processing is running continuously. Therefore, if the signal processing and the visualization are performed on the same GPU, competition for GPU resource will happen when the volume rendering starts while the B-scan processing is still going on, which could result in instability for both tasks.
(2) It will be more convenient to enhance the system performance from the software engineering perspective. For example, the A-scan processing could be further accelerated and the point spread function (PSF) could be refined by improving algorithms with GPU-1, while more complex 3D image processing tasks such as segmentation or target tracking can be added to GPU-2.

In our experiment, the B-scan size is set to 256 A-scans with 1024 pixel each. Using the GPU based NUFFT algorithm, GPU-1 achieved a peak A-scan processing rate of 252,000 lines/s and an effective rate of 186,000 lines/s when the host-device data transferring bandwidth of PCIE-x16 interface was considered, which is higher than the camera's acquisition line rate. The NUFFT method was effective in suppressing the side lobes of the PSF and in improving the image quality, especially when surgical tools with metallic surface are used. The C-scan size is set to 100 B-scans, resulting in 256×100×1024 voxels (effectively 250×98×1024 voxels after removing of edge pixels due to fly-back time of galvanometers), and 5 volumes/second. It takes GPU-2 about 8 ms to render one 2D image with 512×512 pixel from this 3D data set using the ray-casting algorithm [8].

### Results and Discussion

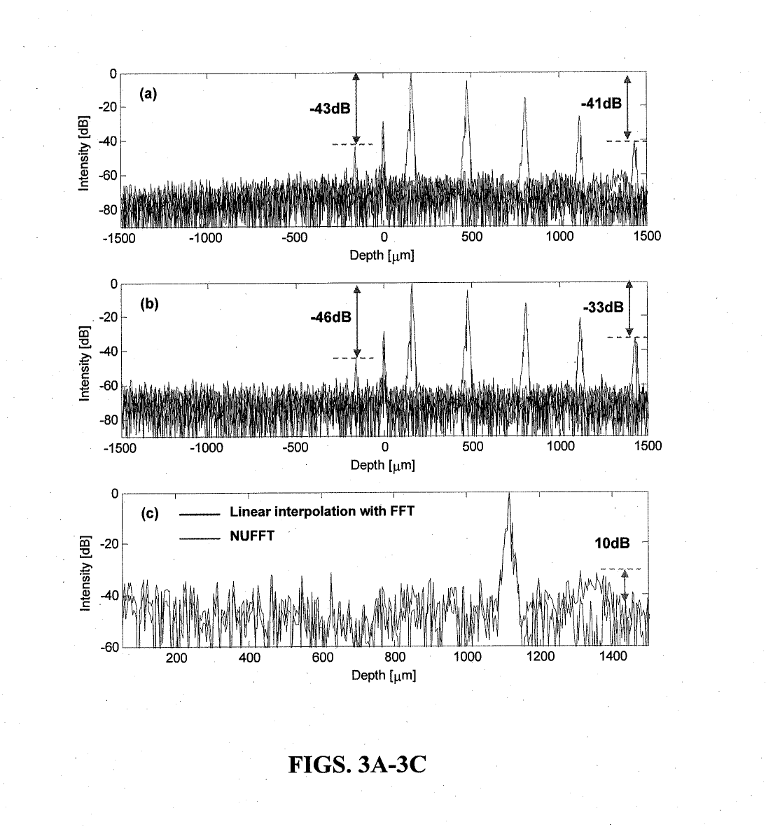

First, we tested the optical performance of the system using a mirror as the target. At one side of the zero-delay, PSFs at different positions are processed as A-scans using linear interpolation with FFT and NUFFT, shown in FIGS. 3A and 3B, respectively. As one can see, using NUFFT processing, the system obtained a conjugate suppression ratio of about 46 dB near the zero-delay position, and a SNR fall-off of 33 dB from zero-delay to the edge. While using linear interpolation, the conjugate suppression ratio is about 43 dB and the SNR fall-off is 41 dB. Moreover, compared to the linear interpolation method, NUFFT obtained a constant background noise level over the whole A-scan range. FIG. 3C presents the comparison of PSFs near the edge by the two methods, where a 10 dB side lobe exists as a result of interpolation error. Therefore, by applying NUFFT in GPU-1, we can obtain high quality, low noise image sets for later volume rendering in GPU-2.

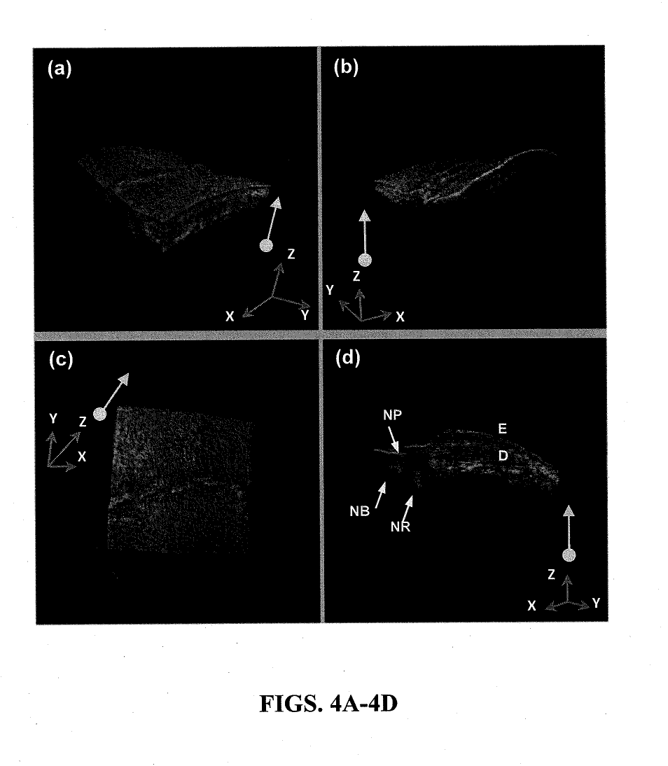

Next, in vivo human finger imaging was conducted to test the imaging capability of biological tissue. The scanning range is 3.5 mm (X)×3.5 mm (Y) lateral and 3 mm (Z) for the axial full-range. The finger nail fold region is imaged as FIGS. 4A-4D (screen captured as Media 1 at 5 frame/second), where 4 frames are rendered from the same 3D data set with different view angles. The arrows/dots on each 2D frame correspond to the same edges/vertexes of the rendering volume frame, giving comprehensive information of the image volume. As noted in FIG. 4D, the major dermatologic structures such as epidermis (E), dermis (D), nail plate (NP), nail root (NR) and nail bed (NB) are clearly distinguishable.

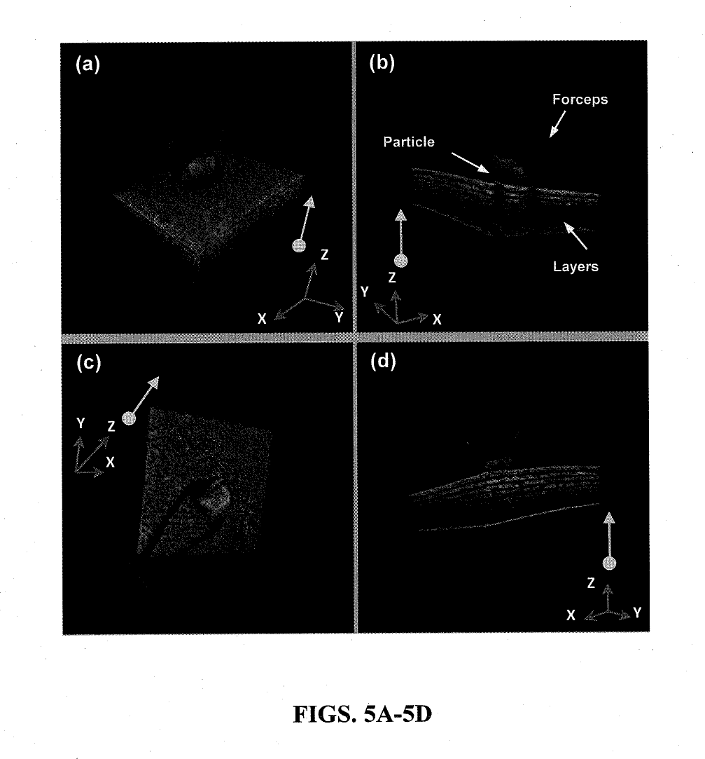

Finally, we performed a real-time 4D full-range FD-OCT guided micro-manipulation using a phantom model and a vitreoretinal surgical forceps, with the same scanning protocol as FIGS. 5A-5D. As shown in FIGS. 5A-5D, a sub-millimeter particle is attached on a multi-layered surface made of polymer layers. The mini-surgical forceps was used to pick up the particle from the surface without touching the surface. As shown in Media 2, multiple volume rendering of the same 3D date set were displayed with different view angles to allow accurate monitoring of the micro-procedure, and the tool-to-target spatial relation is clearly demonstrated in real-time. Compared to the conventional surgical microscope, this technology can provide surgeons with a comprehensive spatial view of the microsurgical region and depth perception. Therefore, this embodiment can be useful as an effective intraoperative surgical guidance tool that can improve the accuracy and safety of microsurgical procedures.

### CONCLUSION

In this example, a real-time 4D full-range FD-OCT system is implemented based on the dual-GPUs architecture according to an embodiment of the current invention. The computing task of signal processing and visualization into different GPUs and real-time 4D imaging and display of 5 volume/second has been obtained. A real-time 4D full-range FD-OCT guided micro-manipulation was performed using a phantom model and a vitreoretinal surgical forceps. This embodiment can provide surgeons with a comprehensive spatial view of the microsurgical site and can be used to guide microsurgical tools effectively during microsurgical procedures.

### REFERENCES

1. K. Zhang, W. Wang, J. Han and J. U. Kang, “A surface topology and motion compensation system for microsurgery guidance and intervention based on common-path optical coherence tomography,” IEEE Trans. Biomed. Eng. 56, 2318-2321 (2009).
2. Y. K. Tao, J. P. Ehlers, C. A. Toth, and J. A. Izatt, “Intraoperative spectral domain optical coherence tomography for vitreoretinal surgery,” Opt. Lett. 35, 3315-3317 (2010).
3. Stephen A. Boppart, Mark E. Brezinski and James G. Fujimoto, “Surgical Guidance and Intervention,” in Handbook of Optical Coherence Tomography, B. E. Bouma and G. J Tearney, ed. (Marcel Dekker, New York, N.Y., 2001).
4. W-Y. Oh, B. J. Vakoc, M. Shishkov, G. J. Tearney, and B. E. Bouma, “>400 kHz repetition rate wavelength-swept laser and application to high-speed optical frequency domain imaging,” Opt. Lett. 35, 2919-2921 (2010).
5. B. Potsaid, B. Baumann, D. Huang, S. Barry, A. E. Cable, J. S. Schuman, J. S. Duker, and J. G. Fujimoto, “Ultrahigh speed 1050 nm swept source/Fourier domain OCT retinal and anterior segment imaging at 100,000 to 400,000 axial scans per second,” Opt. Express 18, 20029-20048 (2010), http://www.opticsinfobase.org/oe/abstract.cfm?URI=oe-18-19-20029
6. W. Wieser, B. R. Biedermann, T. Klein, C. M. Eigenwillig, and R. Huber, “Multi-Megahertz OCT: High quality 3D imaging at 20 million A-scans and 4.5 GVoxels per second,” Opt. Express 18, 14685-14704 (2010), http://www.opticsinfobase.org/oe/abstract.cfm?URI=oe-18-14-14685
7. T. Bonin, G. Franke, M. Hagen-Eggert, P. Koch, and G. Hüttmann, “In vivo Fourier-domain full-field OCT of the human retina with 1.5 million A-lines/s,” Opt. Lett. 35, 3432-3434 (2010).
8. K. Zhang and J. U. Kang, “Real-time 4D signal processing and visualization using graphics processing unit on a regular nonlinear-k Fourier-domain OCT system,” Opt. Express 18, 11772-11784 (2010), http://www.opticsinfobase.org/abstract.cfm?URI=oe-18-11-11772
9. M. Sylwestrzak, M. Szkulmowski, D. Szlag and P. Targowski, “Real-time imaging for Spectral Optical Coherence Tomography with massively parallel data processing,” Photonics Letters of Poland, 2, 137-139 (2010).
10. J. Probst, D. Hillmann, E. Lankenau, C. Winter, S. Oelckers, P. Koch, G. Hüttmann, “Optical coherence tomography with online visualization of more than seven rendered volumes per second,” J. Biomed. Opt. 15, 026014 (2010).
11. K. Zhang and J. U. Kang, “Graphics processing unit accelerated non-uniform fast Fourier transform for ultrahigh-speed, real-time Fourier-domain OCT,” Opt. Express 18, 23472-23487 (2010), http://www.opticsinfobase.org/abstract.cfm?URI=oe-18-22-23472
12. Y. Watanabe, S. Maeno, K. Aoshima, H. Hasegawa, and H. Koseki, “Real-time processing for full-range Fourier-domain optical-coherence tomography with zero-filling interpolation using multiple graphic processing units,” Appl. Opt. 49, 4756-4762 (2010).
13. L B. Baumann, M. Pircher, E. Götzinger and C. K. Hitzenberger, “Full range complex spectral domain optical coherence tomography without additional phase shifters,” Opt. Express 15, 13375-13387 (2007), http://www.opticsinfobase.org/abstract.cfm?URI=oe-15-20-13375
14. NVIDIA, “NVIDIA CUDA C Programming Guide Version 3.2,” (2010).

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. A four-dimensional optical coherence tomography imagining and guidance system, comprising:
an optical coherence tomography system;
a data processing system adapted to communicate with said optical coherence tomography system; and
a display system adapted to communicate with said data processing system,
wherein said optical coherence tomography system is configured to provide data corresponding to a plurality of volume frames per second,
wherein said data processing system is configured to receive and process said data and provide three-dimensional image data to said display system such that said display system displays a rendered real-time three-dimensional image.

2. A four-dimensional optical coherence tomography imagining and guidance system according to claim 1, wherein said data processing system comprises at least one parallel processing unit.

3. A four-dimensional optical coherence tomography imaging and guidance system according to claim 1, wherein said data processing system comprises a first parallel processing unit configured to receive and process said data from said optical coherence tomography system to provide pre-processed data, and
wherein said data processing system comprises a second parallel processing unit configured to receive and process said pre-processed data to provide said three-dimensional image data.

4. A four-dimensional optical coherence tomography imaging and guidance system according to claim 1, wherein said first parallel processing unit is a first graphics processing unit and said second parallel processing unit is a second graphics processing unit.

5. A four-dimensional optical coherence tomography imaging and guidance system according to claim 1, wherein said optical coherence tomography system is a Fourier domain optical coherence tomography system.

6. A four-dimensional optical coherence tomography imaging and guidance system according to claim 5, wherein said optical coherence tomography system is a fiber-optic optical coherence tomography system.

7. A four-dimensional optical coherence tomography imaging and guidance system according to claim 5, wherein said optical coherence tomography system comprises an optical fiber probe for microsurgery.

8. A four-dimensional optical coherence tomography imaging and guidance system according to claim 1, wherein said display system is at least one of a monitor, a head-mounted display or a viewing port.

9. A four-dimensional optical coherence tomography imaging and guidance system according to claim 7, wherein said display system is at least one of a monitor, a head-mounted display or a viewing port to provide real time microsurgical guidance.

10. A four-dimensional optical coherence tomography imaging and guidance system according to claim 4, wherein said second graphics processing unit is further configured to perform at least one of segmentation, information overlay, or image overlay of said rendered real-time three-dimensional image.

11. A four-dimensional optical coherence tomography imaging and guidance system according to claim 5, wherein said optical coherence tomography system is a functional optical coherence tomography system to perform at least one of spectroscopic, speckle, Doppler or optical coherence tomography systems, or any combination thereof.
